(19) United States
(12) Patent Application Publication
(10) Pub. No.: US 2020/0010785 A1
(43) Pub. Date: Jan. 9, 2020

(54) System and method for treating beverages

(71) Applicant: Robert David Monahan, Fort Collins, CO (US)

(72) Inventor: Robert David Monahan, Fort Collins, CO (US)

(21) Appl. No.: 15/998,113

(22) Filed: Jul. 5, 2018

(51) Int. Cl. C12G 3/07; C12H 1/22

(52) U.S. Cl. CPC C12G 3/065; C12H 1/22

(57) ABSTRACT

Beverages such as beer, wine and spirits, are treated in a flow-through process using vessels with flavor-producing wood panels with cross-grain cuts to accelerate the treatment process. The panels can be replaced easily and at low cost. The vessel is made of liquid-impervious material such as stainless steel and can operate at relatively high pressures, and with a heated liquid, to further accelerate the treatment process

This invention relates to treating beverages; more specifically, aging and/or flavoring beverages such as beer, wine and spirits.

A long-standing problem in the production of beverages lies in the aging and flavoring of the beverages. Often, beverages are treated by holding them in wooden barrels, such as white oak barrels. This both flavors the beverage and micro-oxygenates the beverage by contact with oxygen entering the barrel through the pores of the wooden barrel wall. Often, the beverage must remain in the barrel for a relatively long time, resulting in losses of the beverage due to slow leakage, storage costs and the use of substantial quantities of wood, which is a limited natural resource, and often is expensive.

Barrels have been developed which use cross-grain cuts on the interior surfaces of the staves to greatly accelerate the infusion of liquid and the aging and flavoring the beverage, thus reducing the time and cost of production. U.S. Pat. No. 9,212,343 shows such a highly advantageous barrel and stave construction.

The problems of wood usage and beverage loss due to leakage have been greatly alleviated by the development of barrels made out of liquid-impervious material, such as stainless steel, with solid seams to halt leakage, and with relatively small wood panels fitted into openings in the side wall of the container to provide the functions usually provided by the solid wood walls of the traditional wooden barrel. The barrels are sold under the trademark “Squarrel” by Squarrel Cooperage Ltd. of Minnesota, USA. The barrels can be cylindrical, but the preferred shape, for most uses, is a square shape, which takes up less storage space than the traditional round barrels. The small panels are relatively inexpensive and can be replaced with new panels when needed, thus saving cost and wood as compared with standard barrels. All or selected ones of the panels can have cross-grain cuts on the inside surface, if accelerated infusion is desired, or the panels can be smooth, if desired. U.S. Pat. No. 9,885,010 shows such a highly desirable barrel structure.

Another barrel structure, shown in published US patent application 2016/0355772, published on Dec. 8, 2016, is one in which one or more air-containing hollow wooden containers is mounted in the body of a housing with liquid-impervious walls and seams. The outer surfaces of the air containers contact the liquid being treated. The outer surfaces of the air container may have cross-grain cuts to accelerate aging and flavoring, and micro-oxygenation occurs between the air in the hollow containers and the liquid outside. The relatively small wooden containers can be replaced when the flavor/aging ability of the wood is used up, rather than replacing an entire wooden barrel. Wooden panels in side-wall openings can be used in addition to the air containers, to further accelerate infusion and flavoring.

In the past, in order to increase production of flavored beverages, such as beer, some systems have been used in which the beverage has been pumped through a tank in which wood chips or other wood pieces have been floated. It is believed that these systems have not been successful.

Another similar proposal was to pump beer through a series of ordinary wooden barrels in order to increase production. The beer was re-circulated through the barrels a number of times to give the beer a desired characteristic. This proposal is not believed to have been widely adopted. It has the disadvantage of having to discard or rebuild the barrels after a certain period of use, and other drawbacks which will become apparent from the description that follows.

Accordingly, it is an object of the invention to provide a system and method for treating a beverage to provide accelerated wood flavoring and aging of the beverage by flowing it through a treatment structure which produces beverages more quickly and with less usage of wood and structure than in the past.

It also is an object to provide such a system and method in which leakage and other waste are minimized, that are easier and less costly to maintain, and require significantly reduced capital expenditure, both initially, and over an extended time of use, compared with prior systems.

In accordance with the present invention, the forgoing objectives are met by the provision of a system in which a beverage is pumped through a vessel having liquid-impermeable side-walls and seams, with either an array of wood panels in the side-wall(s), or a hollow, air-filled wooden container mounted in the vessel, or both, to flavor and micro-oxygenate the beverage. The beverage can be re-circulated through the vessel, if desired, to give the beverage a desired characteristic.

The inside surfaces of the panel, or the outside surfaces of the air-filled container can have cross-grain cuts to enhance the infusion rate of the wood.

The panels can be replaced, at moderate cost, and with relative ease, when the infusion capabilities of the wood is exhausted, or when flavor characteristics of the beverages are to be changed.

Different varieties of wood can be used in the panels in any desired combination, in order to create a different flavor or other characteristic.

Plural vessels can be used, connected in series or parallel, in order to alter the production characteristics of the system, and for other purposes.

The foregoing and other objects and advantages of the invention will be set forth in or apparent from the following description and drawings.

### IN THE DRAWINGS

FIG. 1 is a schematic view of one embodiment of the invention;

FIG. 2 is a schematic view of another embodiment of the invention;

FIG. 3 is a schematic view of a further embodiment of the invention;

FIG. 4 is a schematic view of a still further embodiment of the invention;

FIG. 5 is a perspective view, partially broken-away, of a component of one of the vessels used in the systems of FIGS. 1-3;

FIG. 5A is a cross-sectional view taken along line 5-5 of FIG. 5;

FIG. 6 is a perspective, partially broken-away view of one of the vessels shown in FIGS. 1-4;

FIG. 7 is a perspective, partially broken-away view of another vessel for use in the systems of FIGS. 1-4;

FIG. 8 is a cross-sectional view taken along line 8-8 of FIG. 6;

FIG. 9 is a cross-sectional, partially broken-away view taken along line 9-9 of FIG. 7; and

FIG. 10 is partially broken-away bottom plan view of a portion of the vessel shown in FIG. 6.

### DETAILED DESCRIPTION

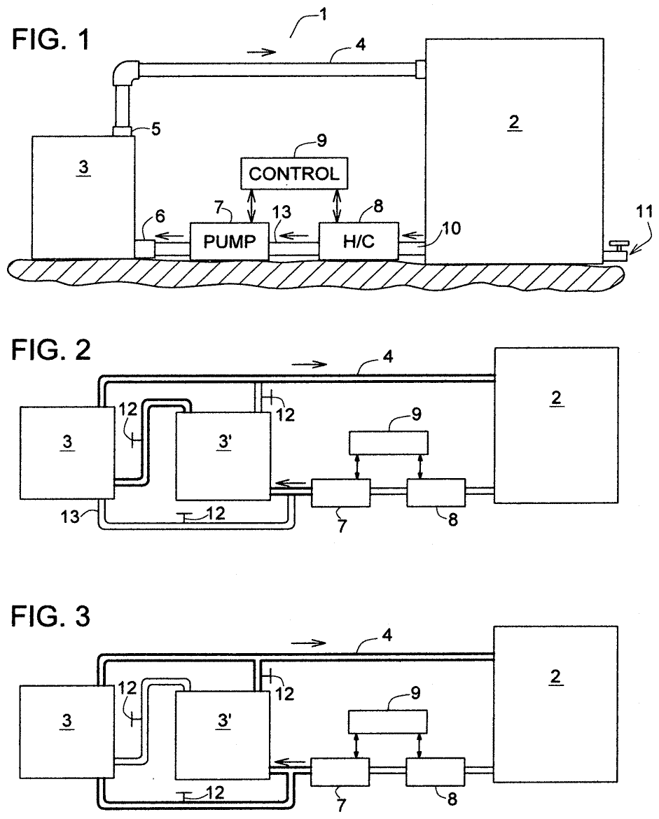

FIG. 1 shows, schematically, a system 1 for treating beverages to enhance their flavors and maturation. The system comprises a storage container or vat 2, a treatment vessel 3, a pump 7, a heating/cooling unit 8, and a control unit 9.

A first conduit 10 delivers liquid from the vat 2 to the vessel 3 through the heating/cooling unit 8, the pump 7, a conduit 13, an inlet 6, and into the unit 3, out through an outlet 5, through a return conduit 4, and into the vat 2.

The control unit 9 is a unit of standard design and is used to control the H/C unit 8 to either heat or cool the liquid to a desired temperature. Often, it will be used to heat the liquid to a relatively high temperature to maximize the infusion produced by the vessel 3. It will be used to cool the liquid if the temperature exceeds process limits.

The control unit 9 can be used to control the pump 7 and uses standard pressure control means to set the outlet pressure from the pump and the flow rate of liquid through the vessel 3, usually to set the pressure a high level to maximize the effect of the vessel on infusion of the liquid and resulting flavor characteristics.

### Preferred Treatment Vessel

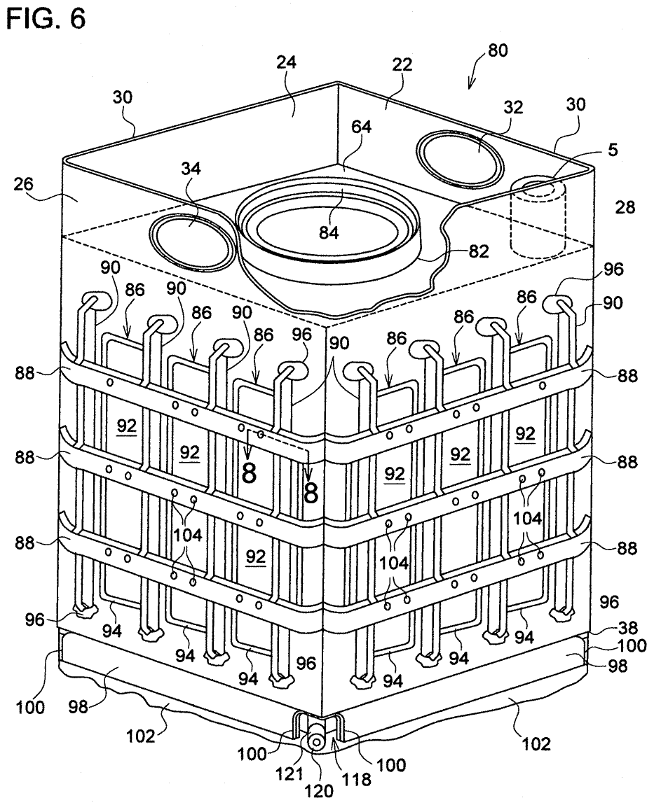

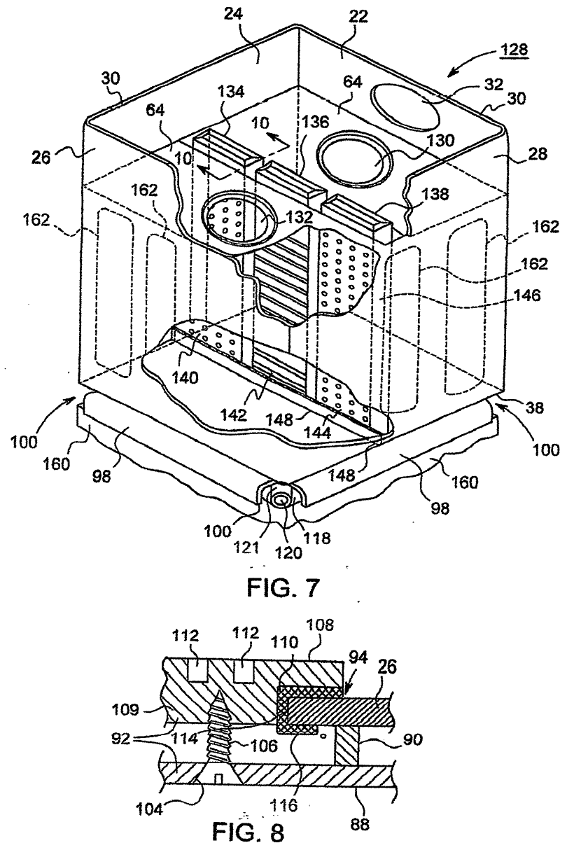

FIG. 6 shows a preferred treatment vessel. The vessel shown in FIG. 6 is essentially the same as the vessel 80 shown in FIG. 7 of U.S. patent application Ser. No. 15/170,267, filed Jun. 1, 2016 and published on Dec. 8, 2016 under No. 2016-0355772-A1.

The vessel 80 has the shape of a rectangular parallelpiped. It has a side-wall 30 made up of four rectangular stainless steel panels 22, 24, 26, 28 connected together along solid, basically leak-free stainless seams formed by bending or welding.

A top wall 64 and a bottom wall 38 are welded to the side walls to form a leak-free container. The top wall 64 is recessed to form an upstanding flange with an upper edge 30 around the top of the vessel. A pair of hand-holes 34 and 32 are formed in the upper portions of the side wall panels 26 and 22, respectively to aid in lifting the vessel. A large central access opening 84 with a base 82 is provided in the top wall 64, and a liquid-tight cover (not shown) is used to close the vessel and open it. The access opening is made large enough to admit a human hand holding a wooden panel to be installed or removed from the vessel.

A lower flange 98 extends downwardly from the bottom wall 38 to form a flanged receptacle for the upper edges 102 of another vessel upon which it sits on so that the vessels can be stacked atop one another securely for economical use of warehouse storage space.

In each of the four side-wall panels there are three vertically-elongated openings 86. Mounted in each opening 86 is a wooden panel 92. Each panel is mounted and held securely in covering relationship to the opening 86, so that there is little or no leakage of the liquid in the vessel through or around the edges of the panels 92.

A holding structure for the panels include a pair of vertical stainless steel ribs 90 on both sides of each opening 86, and a plurality of horizontal cross-bars 88 welded to each of the vertical ribs. Each of the ribs is welded to one of the side panels at the rib ends 96. This grid structure provides a strong support for mounting the panels 92 to cover the openings 86.

Each of the cross-bars 88 has a pair of holes 104 for receiving wood screws to be inserted through the holes and into the wood panels to pull the panels 92 tightly against the edges of the holes 86.

FIG. 8, which is a cross-sectional view taken along line 8-8 of FIG. 6, shows a screw 106 driven through one of the holes 104 into one of the panels 108. A gasket 94 fits into an edge recess 110 and has two other sections 114 and 116 to wrap around the edge of the side-wall panel 26 to ensure good sealing. Two grooves 112 in the inner surface of the wood panel are illustrative of grooves that can be used to greatly accelerate infusion of the liquid into the wood and thus accelerate flavoring and aging of the beverage. (Actually, the grooves 112 are shown rotated 90 degrees from their actual orientation, for the sake of clarity in the drawings. The grooves should be cut across the grain of the wood, as shown at 93 in FIGS. 5 and 5A of the drawings.)

The wood panels 92 provide flavoring and aging functions superior to ordinary barrel staves, while being exposed to the outside air to allow microxygenation.

When a wood panel has been used one or more times, it can be replaced with a new panel by the simple process of removing the screws 104 holding the panel in place, inserting an arm through the top opening 84, grasping the panel and removing it, and then reversing the procedure to install a fresh panel.

The wood panels are relatively short, compared to normal barrel staves, and actually can be made from the scrap produced in making normal staves. Thus, the wood panels can be relatively inexpensive.

The vessel bodies can be cleaned and re-used over and over, whether they are made of stainless steel or another type of liquid-impervious material.

If desired, the wood panels either can be of the same type of wood (e.g., all white oak), or they can be of selected different types (e.g, white oak and cherry) to produce a different flavor in the liquid.

For the purposes of this invention, an outlet spout 5 (FIG. 6) is added at the top wall 64. It is adapted to be normally closed, until a conduit 4 is coupled to it to open the outlet.

Referring again to FIG. 6, the inlet opening 6 of FIG. 1 comprises a pipe 120 with a coupling 121 extending out from one corner 118 of the vessel through an opening formed by cuts 100 at the corner. FIG. 10 is a view looking upwardly at the bottom wall 38 showing that the outlet 120 is connected to the interior of the vessel through a pipe 124 connected to a vertical pipe 126 connecting into the vessel's interior.

When used in the systems of FIG. 1, 2, 3 or 4, the vessel is believed to provide a performance superior that of prior systems. Because the liquid being treated moves through the vessel, it is believed that there is even faster infusion of the liquid, and faster flavoring and aging of the beverage. The liquid flow is believed to cause faster flushing of liquids into and out of the cross-grain cuts, with a commensurate increase in the rate of treatment, without the filling of many separate vessels to treat the same volume of liquid. This can save in capital expenditure and make more efficient use of the treatment vessels

Further, the vessel 80 is capable of operating under substantial pressure, which often is necessary and desirable to increase the infusion rate even further in such systems. Because there are no ordinary wood-to-wood seams, as in a standard barrel, but only solid material in the seams, the pressure in the vessel can be much higher. For example, an ordinary wooden barrel often cannot stand pressures much above about 5 p.s.i.g. without the head blowing off or excess leakage occurring, whereas the vessel 80 can operate successfully at pressures above 100 p.s.i.g.

### Alternative Systems

FIGS. 2 and 3 show modifications of the system in FIG. 1.

FIG. 2 shows a system like that of FIG. 1, except that two vessels 3 and 3′ are connected in series with one another.

Various added conduits are used to make a convertible system, which can be used with valves 12 to connect the vessels in series by enabling the conduits shown in heavy lines in FIG. 2, or to connect the vessels in parallel, as shown in heavy lines in FIG. 3. Also, the valves 12 can be set to disable one vessel and use only the other, when one of the vessels needs servicing, for example.

The number of vessels used in a system of the invention is not limited to two; more vessels can be added as needed. Furthermore, the liquid can be re-circulated through the system until the beverage has reached a desired flavor or other characteristic.

As in the FIG. 1 embodiment, the liquid flow rate can be controlled by using the control unit 9 to control the pump 7, and the temperature of the beverage being processed can be controlled by using the control unit 9 to control the heating/cooling unit 8, which can consist of a heat exchanger in combination with either a refrigeration unit or a heater.

When a batch of beverage has been treated as desired, the contents of the vat 2 can be emptied through the outlet spout 11 (FIG. 1), and a new batch can be piped in for treatment.

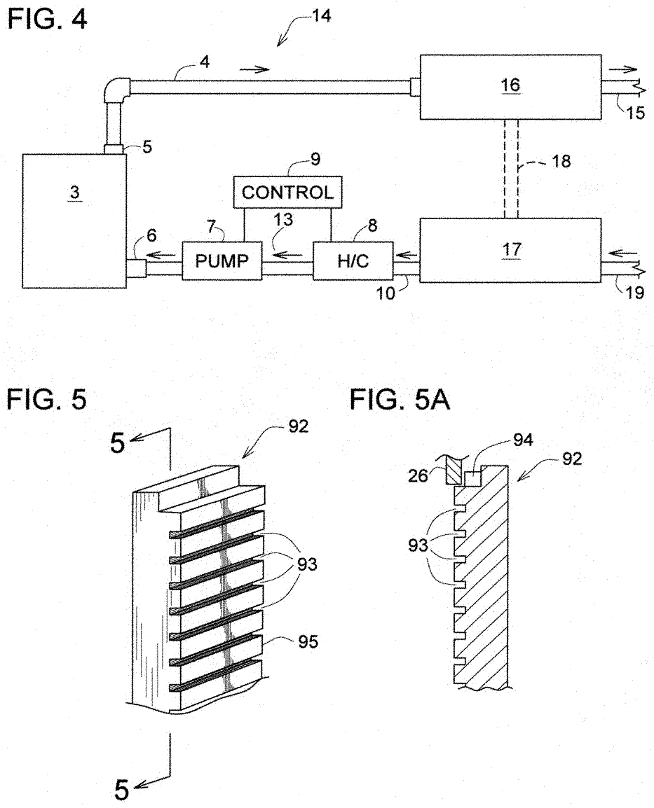

The system 14 shown in FIG. 4 is like the system of FIG. 1, except that two separate containers 16 and 17 are provided instead of one. This facilitates “one-pass” processing where the process parameters are set so that the desired characteristics of the liquid are reached with only one pass through the vessel 3.

The liquid to be processed is delivered through a line 19 into a tank 17 serving as a reservoir. Then the liquid is treated by the vessel 3, and the finished brew is sent to a second container, and is delivered from there over an outlet line 15 to the next station where the liquid is processed further.

An optional bypass line 18, with suitable valving (not shown) is provided to recirculate the liquid if it should need further treatment.

The system 14 in FIG. 4 separates the finished product from the incoming unprocessed liquids for fast processing.

### Alternative Vessel Construction

FIG. 7 shows an alternative vessel 128 which is like the vessel 80 of FIG. 6, with certain exceptions. Instead of, or in addition to the wood panels in the side walls, a vertical “air box” structure is positioned in the center of the vessel.

The air box structure comprises three hollow wooden boxes 134, 136 and 138 mounted centrally

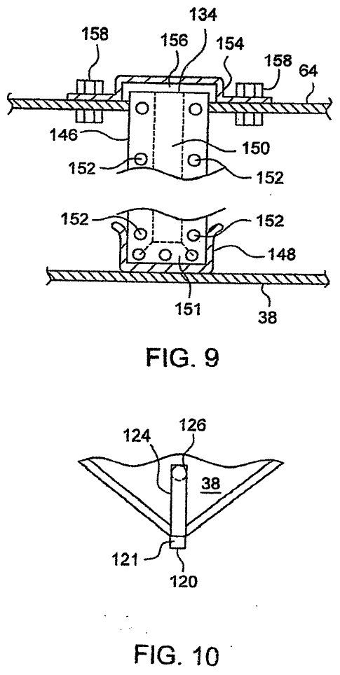

in the vessel 128. The hollow space in each air box is indicated at 150 in FIG. 9. The hollow space is relatively narrow in order to maximize the amount of liquid that can be contained in the vessel. The volume of air in the boxes is believed to be adequate to provide proper oxygenation of the liquid. However, if further oxygenation is desired, the boxes can be supplied with oxygen-enhanced air. Any liquid leakage into the boxes can be removed and returned to the liquid by the use of an ordinary sump pump.

Each of the air boxes consists of a pair of panels 140, 142 or 144 (only one being shown in FIG. 7) with narrow end pieces 146 (FIG. 9) and a bottom piece 151 joined to the panels at tongue-in-groove joints, with screws 152 driven into the joints to form liquid-tight boxes. Both panels of each box has a series of cross-grain cuts (straight cuts and holes, e.g.) as shown at 140, 142, and 144 in FIG. 7.

The air boxes are mounted in a channel member 148 (FIGS. 7 and 9) welded to the bottom 38 of the vessel, and the open tops of the boxes extend upwardly through a slot in the top wall 64, and a cap 154 with a gasket 156 is secured to the top wall by fasteners 158 and covers the open tops of the boxes to prevent liquid from entering them. The cap 154 is shaped to cover all parts of the slot in the top wall 64 to prevent leakage. The seal provided by this structure is air-tight in order to permit treatment of the liquid under pressure. Spaces are provided between the air boxes in order to allow circulation of the liquid in the vessel.

If microoxygenation of the liquid is otherwise adequate, (as when side-wall panels are used as shown at 162 in FIG. 7 in addition to the air boxes) then vertical panels with cross-cuts such as panels 140, 142 and 144 may be adequate to flavor or otherwise treat the liquid, without providing air reservoirs in the form of boxes.

Two large sealable access holes 130 and 132 are provided in the top wall 64 to permit access for the hand and arm of someone to remove and replace the side panels, in the embodiment in which the side panels are used.

In the FIG. 7 unit 128, a lower flange 98 is used to facilitate nesting with another unit 160 below it, and an outlet 5 and an inlet 120 are provided, as in the FIG. 6 embodiment.

In use, the vessel 128 can be used in the same way as the vessel 80 of FIG. 6, except that the air boxes are replaced, either instead of, or in addition to, the side panels.

It is believed that the vessel 128 can be used to advantage when it is desired that the vessel contain more liquid than the usual 10, 30 or 60 gallon sizes in which the vessels 80 usually are sold.

Since it may not be necessary to stack the vessels used in the system of the invention, the vessels can have other shapes, such as cylindrical, if desired.

### Process Parameters

In using the system of the invention, certain advantageous process parameters can be used.

For example, in treating beer, as in other treating other beverages, it is highly advantageous to treat the beer under relatively high temperatures and pressures. The beer, if treated prior to fermentation, can be heated safely to temperatures up to 90 degrees Celsius. This greatly aids the flavoring and maturation process. Even if treated later in the brewing process, say, right after fermentation but before going to the “bright tank” for carbonation, fairly high temperatures and pressures can be used. The heating/cooling unit 8 can be used both to heat the liquid, or to cool it if the temperature gets too high.

It also greatly aids the process if the beer is treated under pressure. As noted above, the vessels disclosed herein are capable of operation with liquid under pressures of more than 100 p.s.i.g.

In general these principles apply to other beverages as well. In spiritous beverages, such as whiskey, relatively high pressures and temperatures also can be used to advantage.

Although it may be advantageous to re-circulate the beverage through the system, usually it is preferred to process a beverage in only one pass. This can be facilitated by using multiple vessels connected in series, or in parallel, and/or by simply controlling the flow rate to increase the dwell-time of the beverage in the vessel(s), and by using a system such as that shown in FIG. 4.

Vessels used in parallel, as shown in FIG. 3, can be used to provide flavoring with one type of wood in one vessel, and another type of wood in the other vessel. Combining the outputs of those vessels produces a blended beverage.

1. A system for treating beverages, said system comprising
(a) a treatment vessel comprising:
(1) a body made of liquid-impervious material and including at least one side-wall, a bottom wall, and a top wall, said walls being secured together at seams made of solid liquid-impervious material;
(2) a plurality of openings in said side-wall;
(3) a plurality of wood panels, each being removably secured in covering relationship to one of said openings and positioned to contact a liquid contained in said vessel;
(4) a liquid inlet port and a liquid outlet port for said vessel;
(b) liquid conduits for conducting a liquid to be treated to said inlet port of said vessel, and from said outlet port of said vessel to a delivery location,
(c) a pump for pumping liquid under pressure through said conduits and said vessel and out of said vessel to said delivery location.

2. A system as in claim 1 including at least two of said vessels and conduits connecting said vessels together with one another and to said delivery location.

3. A system as in claim 1 in which said wood panels are selected from the group consisting of
(1) all panels made of the same type of wood, and
(2) different panels made of selected different types of wood.

4. A system as in claim 1 in which each of said wood panels has an inside surface that contacts a liquid in said vessel and an outside surface that contacts the air around said vessel, and at least one of said wood panels has a plurality of cross-grain cuts in its inside surface.

5. A system as in claim 1 in which each of said wood panels is broader than the opening that it covers, and the edges of said panel overlap the edges of said opening on the inside of said vessel, and a holding structure on the outside of said vessel for holding and pulling said panel edges against the inside of said sidewall to form a liquid-tight seal between said panel and said side wall.

6. A system as in claim 1 including a container at said delivery location in which said liquid to be treated is stored in the same container as the liquid that has been processed.

7. A system as in claim 1 including a receiving container at said delivery location, and a separate source for the liquid to be treated.

8. A system as in claim 1 including a heater for heating the liquid to be treated, and a pump to deliver liquid to said vessel at an elevated pressure.

9. A system for treating beverages, said system comprising
(a) A vessel having a body made of liquid-impervious material and including at least one side-wall, a bottom wall, and a top wall, said walls being secured together at seams made of solid liquid-impervious material;
(b) a hollow air container in said vessel, said air container having at least one wooden side-wall and a bottom wall secured to said side wall,
(c) said air container being dimensioned and mounted in said vessel with said wooden side wall in a position to contact a liquid in said vessel without liquid flowing into said air container,
(d) a liquid inlet port and a liquid outlet port for said vessel;
(e) liquid conduits for conducting a liquid to be treated to said inlet port of said vessel, and from said outlet port of said vessel to a delivery location, and
(f) a pump for pumping liquid under pressure through said conduits to and from said vessel and to said delivery location.

10. A system as in claim 9 including at least two of said vessels and conduits connecting said vessels together with one another in an arrangement selected from the group consisting of a parallel connection and a serial connection.

11. A system as in claim 9 in which said side wall is made of wood panels, each of said panels having a first surface contacting said liquid and an opposite surface contacting the air in said box, at least one of said panels having a plurality of cross-grain cuts in said first surface.

12. A system as in claim 9 in which said side-wall of said vessel has a plurality of openings, and a plurality of wood panels, each being removably secured in covering relationship to one of said openings and positioned to contact a liquid contained in said vessel.

13. A method of treating a beverage, said method comprising
(a) providing a system with a wood panel flavor structure as in claim 1,
(b) pressurizing a liquid beverage to a pre-determined pressure and flowing said beverage through said vessel, and transporting said liquid out of said vessel to a delivery location.

14. A method as in claim 13 including heating said liquid to an elevated temperature, as well as pressurizing it, and flowing said beverage through said vessel.

15. A method as in claim 13 including the step of changing the wood panels in said vessel when it is determined that the used panels no longer have adequate flavoring capacity.

16. A method as in claim 13 including at least two of said vessels, connectd either in parallel or in series to augment the treated liquid production of the method.
